(19) United States
(12) Patent Application Publication
(10) Pub. No.: US 2026/0283076 A1
(43) Pub. Date: Sep. 24, 2026

(54) A TINE SUPPORT

(71) Applicant: PLOEGER OXBO HOLDING B.V., Roosendaal (NL)

(72) Inventor: Hendrik Willem BREURE, Roosendaal (NL)

(21) Appl. No.: 19/476,080

(22) PCT Filed: Apr. 16, 2024
(86) PCT No.: PCT/NL2024/050194

§ 371 Date: Oct. 16, 2025

(30) Foreign Application Priority Data
Apr. 17, 2023 (NL) 2034594

(51) Int. Cl. A01D 80/02

(52) U.S. Cl. CPC A01D 80/02

(57) ABSTRACT

A tine support for a crop pick-up device includes at least two support elements. At least one tine is mounted on each support element, and each support element also has a connecting region adapted to provide a non-rotatable connection to a shaft of the crop pick-up device. A crop pick-up device includes the tine support. A self-propelled or pulled agricultural machine, for example a self-propelled merger includes the crop pick-up device.

### CROSS-REFERENCE TO RELATED APPLICATION

The present application is a National Stage Application of PCT International Application No. PCT/NL2024/050194 filed on Apr. 16, 2024, which claims priority to Patent Application 2034594, filed with The Netherlands Patent Office on Apr. 17, 2023, the disclosure of which is incorporated herein by reference in its entirety.

### FIELD OF THE INVENTION

The invention relates to a tine support for a crop pick-up device comprising at least two support elements, wherein on each support element at least one tine is mounted, and each support element further having a connecting region adapted to provide a non-rotatable connection to a shaft of the crop pick-up device.

The invention also relates to a crop pick-up device comprising a tine support of this disclosure and to a self-propelled or pulled agricultural machine, for example a self-propelled merger comprising such a crop pick-up device.

### SUMMARY OF THE INVENTION

WO2019/151095 discloses a tine support which can be mounted on a shaft and/or exchanged if required. This tine support uses a single fastening clamp to connect two support elements in a detachable manner to each other and on a shaft of the crop pick-up device. A drawback of the known tine support is that for replacing one damaged tine the fastening clamp should be opened and the two support elements have to be disconnected from each other, i.e. the complete tine support must be disassembled for replacing a single tine.

It is an object of the present invention to provide an improved tine support in which a tine can be replaced relatively easily and/or fast without requiring to disassemble the complete tine support.

The tine support for a crop pick-up device comprises at least two support elements, wherein on each support element at least one tine is mounted. Each support element further has a connecting region adapted to provide a non-rotatable connection to a shaft of the crop pick-up device. The tine support comprises at least two fasteners and a connection ring configured to receive at least end sections of the at least two fasteners in a connecting manner, wherein by means of the at least two fasteners and the connection ring the at least two support elements and the at least one tine on each support element are detachably connected to each other.

By means of the tine support, it is possible to replace a tine relatively easily and/or fast by loosening the fastener that is detachably connecting the tine to the support element. By means of the fasteners and the connection ring of the tine support of this disclosure each fastener has a double function, in that each fastener connects the support element to the connecting ring and connects the tine to the support element. Before connecting the tine support to the shaft of the crop pick-up device, the connection ring is positioned in an endless manner around the shaft. In addition, the fasteners and the connection ring provide a robust and/or reliable tine support in an assembled state for picking-up crop.

In one aspect, each connecting region comprises a recess for receiving a portion of the connection ring.

The connection ring can be provided in the recess of the support element in a relatively loose manner, wherein after receiving a fastener end of the fastener and fastening the tine on the support element by means of the fastener, the connection ring is connected in the recess of the support element by means of the fastener. In the connected state, the support element, or at least a portion of the support element, is located between the tine and the connection ring. The recess is designed to receive the connection ring portion completely in a non-protruding manner such that in an assembled state of the tine support around the shaft of the crop pick-up device each connecting region of each support element provides a non-rotatable connection to the shaft of the crop pick-up device, in particular a non-rotatable connection without play. The recess may for example be designed to accommodate half a connection ring in each support element.

In another aspect, the tine support further comprises tine support structures, wherein on each tine support structure at least one tine is mounted or mountable, and each tine support structure is detachably connectable to the support member by means of one of the fasteners and the connection ring.

In this manner it is also possible to replace tine support structures individually if necessary in a relatively fast and easy manner. Each tine may be a double tine, with two spiral winding portions and a fastening section between the two spiral winding portions,, wherein each tine support structure axially extends through the at least two spiral winding portions. Each tine support structure comprises a through hole for receiving the fastener. By means of the tine support structure the central fastening section can be connected to the support element by means of the fastener. The tine with the two winding portions is stably supported by means of the tine support structure which ends protrude out of the winding portions seen in an axial direction of the winding portions, which also reduces the risk that a tine breaks and comes off the tine support. In use, the forces which are exerted on the central fastening section connected to the support element by means of the fastener are relatively large. If during use, a fastening section of a tine breaks, the tine support structure prevents that a tine will be broken off and such a tine remains connected to the support element by means of the tine support structure. Such a tine that has broken off the tine support has all kinds of adverse effects on nature and/or on machines doing subsequent agricultural processes on the field that can be prevented or at least reduced by means of the tine support structure, because the tine support extends completely through the two winding portions of the tine and its ends are connected to the support element in an assembled state of the tine support.

In a further aspect, each support member comprises at least two opposing carrying members and each carrying member is configured to carry one of the two ends of the support structure.

By means of the carrying members the support structure is carried in a releasable manner such that replacement of the support structure can be effected in a relatively fast and easy manner.

The connection ring may comprise an inner surface adapted for surrounding the shaft in a rotatable manner. The connection ring is provided around the shaft in a manner that the connection ring can be manually rotated around the shaft, i.e. the connection may be contactless with the shaft or in a manually rotatable contact with the shaft. It is also possible that the inner surface of the connecting ring has a shape providing a non-rotatable connection with the shaft.

Each support element may be designed as a half shell-like construction, wherein the two support elements in an assembled state provide a shell-like construction enclosing the connection ring. In this manner a strong and reliable tine support can be provided which can be assembled and/or disassembled in a relatively fast and simple manner for enclosing the connection ring completely.

Each support element may comprise at least one alignment element, for example a female recess and/or a male projection, for aligning the support elements with each other before connecting the support elements to each other by means of the fasteners and the connection ring. By means of the alignment elements it is impossible or at least relatively difficult to connect the support elements in an incorrect manner to each other.

The invention also relates to a crop pick-up device comprising a tine support of this disclosure. Reference is made to WO2022/045883 disclosing a known crop pick-up device which is indicated in this document as a product pick-up mechanism for picking up a plant material product from the land. Reference is also made to WO2020/046114 disclosing an agricultural machine comprising a product pick-up mechanism. The agricultural machine shown in the figures of WO2020/046114 is a self-propelled merger.

### BRIEF DESCRIPTION OF THE FIGURES

The above-described aspects will be explained below by means of exemplary embodiments in combination with the figures. However, the invention is not limited to the exemplary embodiments described below. Rather, a number of variants and modifications are possible which also use the inventive idea and therefore fall within the scope of protection. In particular, the possibility of combining the features/aspects which have only been mentioned in the description and/or been shown in the figures with the features of the claims, in so far as they are compatible, is mentioned.

FIGS. 1a, 1b show perspective views of a tine support;

FIGS. 2a, 2b show a top view and a cross section C-C indicated in the top view of the tine support shown in FIGS. 1a, 1b;

FIGS. 3a, 3b show details of the tine support shown in FIGS. 1a, 1b.

### DETAILED DESCRIPTION OF THE INVENTION

In the figures, similar components/features are denoted with the same reference signs.

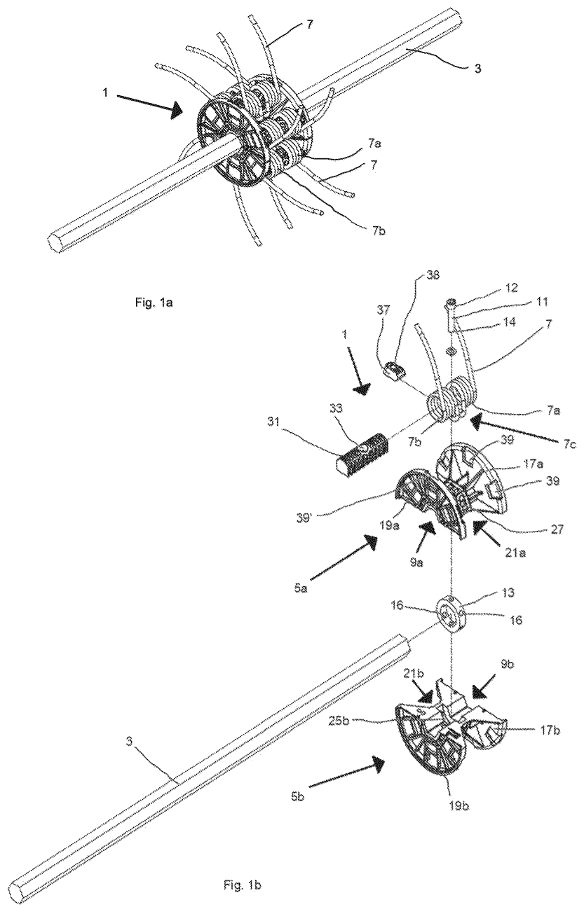

In the FIGS. 1a-3b, a tine support 1 for a crop pick-up device is shown, wherein the tine support 1 is mounted on a shaft 3 of the crop pick-up device. For clarity reasons only one tine support 1 mounted on the shaft 3 is shown in the figures, but in a crop pick-up device to be used in an agricultural machine (reference is made to WO2020/046114 and WO2022/045883) for picking up plant material product from the land, for example hay or a similar product, numerous tine supports 1 are mounted on the shaft 3.

The tine support 1 comprises at least two support elements 5a, 5b, wherein on each support element 5a, 5b at least one tine 7 is mounted. Each support element 5a, 5b has a connecting region 9a, 9b adapted to provide a non-rotatable connection to the shaft 3 of the crop pick-up device.

In the figures each tine 7 is a double tine, including two spiral winding portions 7a, 7b and a fastening section 7c between the two spiral winding portions, but it is also possible to use the tine support of this disclosure in combination with tines (not shown) having a single spiral winding portion or more than two spiral winding portions. The tine support 1 as shown in the figures comprises six double tines 7 (FIG. 1b shows for clarity reasons only one double tine 7).

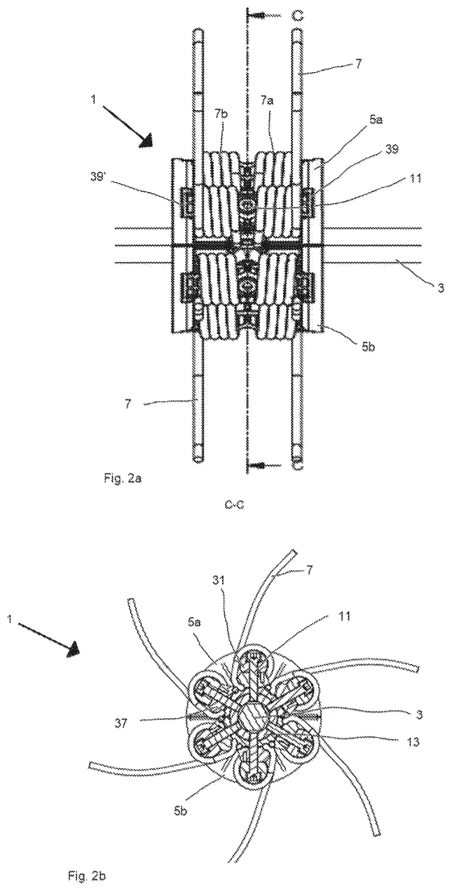

The tine support 1 (see for example FIG. 2b) further comprises at least two fasteners 11 and a connection ring 13 configured to receive at least end sections 13 of the at least two fasteners 11 in a connecting manner, wherein by means of the at least two fasteners 11 and the connection ring 13 the at least two support elements 5a, 5b and the at least one tine 7 on each support element 5a, 5b are detachably connected to each other. On each support element 5a, 5b at least two tines 7 may be mounted or mountable by means of the fasteners 11 and the connection ring 13, wherein in the tine support 1 as shown in the figures three tines 7 are mounted on each support element 5a, 5b.

Each support element 5a, 5b is designed as a half shell-like construction, wherein in an assembled state the two support elements 5a, 5b provide a shell-like construction for enclosing the connection ring 13. Each support element 5a, 5b comprises two half circular shaped outer flanges 17a, 19a, 17b, 19b and a core part 21a, 21b connecting the two half circular shaped outer flanges 17a, 19a, 17b, 19b. An inner portion of each support element 5a, 5b provides the connection region 9a, 9b for the shaft 3, wherein on an outer portion of the core part 21a, 21b and between two half circular shaped outer flanges 17a, 19a, 17b, 19b the tines 7 are mounted on each support element 5a, 5b. Each connecting region 9a, 9b comprises a recess 25b (not shown for connecting region 9a) for receiving a portion of the connection ring 13, in particular a half of the connection ring 13.

The connection ring 13 can be provided in the recess 25b of each support element 5a, 5b in a relatively loose manner, wherein after receiving a fastener end 14 of the fastener 11 and fastening the tine 7 on the support element 5a, 5b by means of the fastener 11, the connection ring 13 is connected in the recess 25b of the respective support element 5a, 5b by means of the fastener 11.

The connection ring 13 has threaded or tapped holes 16 for receiving the threaded end 14 of the fastener 11 to secure in a detachable manner the end 14 and the hole together to assemble the tine holder 1. The fastener 11 may be a bolt-like fastener having a threaded end 14 and a head 12 on the opposite end.

Each support element 5a, 5b comprises at least one through-hole 27 for receiving the fastener 11. In the assembled state of the tine holder 1, the through hole 27 is located between the head 12 and the threaded end 14 of the fastener 11, wherein the support element 5a, 5b is clamped between the connection ring 13 and the head 12 of the fastener 11. The connection ring 13 comprises an inner surface adapted for surrounding the shaft 3 in a rotatable manner, i.e. the inner surface is cylindrical which may be contactless or in minimum contact with the hexagon shaft 3 (see FIG. 2b).

The recess 25b is designed to receive the connection ring portion completely or in a non-protruding manner (see FIG. 2b). In an assembled state of the tine support 1 around the shaft 3 of the crop pick-up device each connecting region 9a, 9b of the support elements 5a, 5b provides the non-rotatable connection to the hexagonal shaft 3 of the crop pick-up device and the support elements 5a, 5b are connected to each other and the shaft 3 without play. This non-rotatable connection to the hexagonal shaft 3 by means of the connecting region 9a, 9b of the support element 5a, 5b and the fasteners 11 connecting the ring 13 to the support element 5a, 5b ensure that the ring 13 is no longer able to rotate around the shaft 3 in the assembled state of the tine support 1. The connection region 9a, 9b of the two connected support elements 5a, 5b may have a polygonal contour, for example hexagonal as shown in the figures, and this contour is shaped to match the shape of the shaft, such as for example the hexagon shaft 3 as shown in the figures.

The tine support 1 further comprises tine support structures 31, wherein on each tine support structure 31 at least one tine 7 is mounted or mountable, and each tine support structure 31 is detachably connectable to the support member 5a, 5b by means of one of the fasteners 11 and the connection ring 13. Each tine support structure 31 comprises a through hole 33 for receiving the fastener 11. By means of the fastener 11 the tine support structure 31 can be clamped between the connection ring 13 and the head 12 of the fastener. Each tine support structure 31 axially extends through the at least two spiral winding portions 7a, 7b. Each support member 5a, 5b comprises at least two opposing carrying members 39, 39′ and each carrying member 39, 39′ is configured to carry one of the two ends of the support structure 31, in particular in a releasable manner if the support structure 31 is not secured by means of the fastener 11 to the connection ring 13. The support structure has at least a partial cylindrical outer shape, for example seen in cross section the outer circumference of the support structure has at least a semi-circular shape. The at least partial cylindrical shape of the support structure provides additional support to the winding portion of the tine 7, in particular as one of the two outwardly extending tine sections bends as a result of a load.

The tine support 1 further comprises a clamping block 37 to be provided between the two windings 7a, 7b of each tine 7 for clamping a central fastening section 7c to the support element 5a, 5b by means of the fastener 11. The clamping block 37 ensures a relatively strong and stable connection between the fastener 11 and the central fastening section 7c. The clamping block 37 comprises a through hole 38 for receiving the fastener 11. Hence, by using one single fastener 11 the clamping block 37, the tine support structure 31, the tine 7, the support element 5a, 5b and the connection ring 13 can be connected to each other.

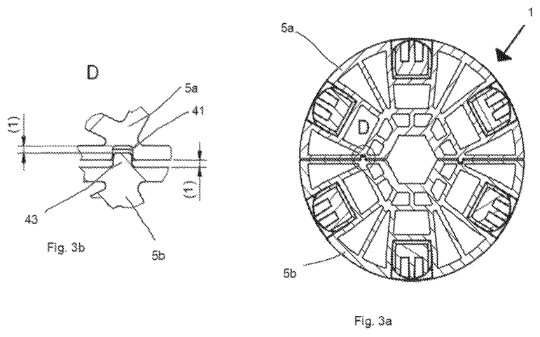

FIGS. 3a and 3b show that each support element 5a, 5b comprises at least one alignment element, for example a female recess 41 and/or a male projection 43, for aligning the support elements 5a, 5b with each other before connecting the support elements 5a, 5b to each other. FIG. 3 b shows detail D as indicated in FIG. 3 a.

1. A tine support for a crop pick-up device comprising at least two support elements, wherein on each support element at least one tine is mounted, and each support element further comprises a connecting region adapted to provide a non-rotatable connection to a shaft of the crop pick-up device:
the tine support comprises at least two fasteners and a connection ring configured to receive at least end sections of the at least two fasteners in a connecting manner, wherein by the at least two fasteners and the connection ring, the at least two support elements and the at least one tine on each support element are detachably connected to each other.

2. The tine support according to claim 1, wherein each connecting region comprises a recess for receiving a portion of the connection ring.

3. The tine support according to claim 1, wherein the tine support further comprises tine support structures, wherein on each tine support structure at least one tine is mounted or mountable, and each tine support structure is detachably connectable to the support member by one of the fasteners and the connection ring.

4. The tine support according to claim 3, wherein each tine is a double tine, with two spiral winding portions and a fastening section between the two spiral winding portions, wherein each tine support structure axially extends through the at least two spiral winding portions.

5. The tine support according to claim 3, wherein each support member comprises at least two opposing carrying members and each carrying member is configured to carry one of two ends of the tine support structure.

6. The tine support according to claim 3, wherein each tine support structure comprises a through hole for receiving the fastener.

7. The tine support according to claim 1, wherein each support element comprises at least one through-hole for receiving one of the two fasteners.

8. The tine support according to claim 1, wherein the connection ring comprises an inner surface adapted for surrounding the shaft in a rotatable manner.

9. The tine support according to claim 1, wherein each support element comprises a half shell-like construction, wherein the two support elements in an assembled state comprise a shell-like construction enclosing the connection ring.

10. The tine support according to claim 1, wherein each support element comprises at least one alignment element, for aligning the support elements with each other before connecting the support elements to each other.

11. The tine support according to claim 1, wherein on each support element at least two tines are mounted or mountable by two of the at least two fasteners and the connection ring.

12. The tine support according to claim 4, wherein the tine support further comprises at least a clamping block between the two winding portions of each tine for clamping the central fastening section to the support element by at least one of the fasteners.

13. The tine support according to claim 12, wherein the at least one clamping block comprises a through hole for receiving one of the fasteners.

14. A crop pick-up device comprising the tine support as claimed in claim 1, wherein the tine support is connected to a rotatable shaft of the crop pick-up device.

15. An agricultural machine, comprising the crop pick-up device of claim 14.

16. The tine support according to claim 1, wherein each support element comprises a female recess and/or a male projection for aligning the support elements with each other before connecting the support elements to each other.

17. A self-propelled merger, comprising the crop pick-up device of claim 14.
